(19) United States
(12) Patent Application Publication
(10) Pub. No.: US 2012/0130774 A1
(43) Pub. Date: May 24, 2012

(54) ANALYZING PERFORMANCE USING VIDEO ANALYTICS

(76) Inventors: Dror Daniel Ziv, Golden, CO (US); Alexander Steven Johnson, Erie, CO (US)

(21) Appl. No.: 13/299,805

(22) Filed: Nov. 18, 2011

Related U.S. Application Data
(60) Provisional application No. 61/415,319, filed on Nov. 18, 2010.
(60) Provisional application No. 61/415,324, filed on Nov. 18, 2010.
(60) Provisional application No. 61/415,325, filed on Nov. 18, 2010.

(51) Int. Cl. G06Q 10/06

(52) U.S. Cl. 705/7.39

(57) ABSTRACT

A method of analyzing performance comprises capturing video data of an interaction between a customer and a worker. The method further comprises analyzing the video data to determine performance metrics for the interaction. The method further comprises generating a scorecard of the performance metrics.

### RELATED APPLICATIONS

This application claims the benefit of U.S. provisional application entitled “METHOD AND SYSTEM FOR ANALYZING PERFORMANCE USING VIDEO ANALYTICS” having Ser. No. 61/415,319 filed on Nov. 18, 2010, which is entirely incorporated herein by reference. This application also claims the benefit of U.S. provisional application entitled “METHOD AND SYSTEM FOR ANALYZING PERFORMANCE USING VIDEO ANALYTICS” having Ser. No. 61/415,324 filed on Nov. 18, 2010, which is entirely incorporated herein by reference. This application also claims the benefit of U.S. provisional application entitled “METHOD AND SYSTEM FOR ANALYZING PERFORMANCE USING VIDEO ANALYTICS” having Ser. No. 61/415,325 filed on Nov. 18, 2010, which is entirely incorporated herein by reference.

### TECHNICAL BACKGROUND

Retail establishments typically utilize video surveillance systems to monitor activities that occur in and around the premises. Service representatives of the retail establishment typically interact with customers to provide assistance and solicit sales. In some instances, the manner in which service representatives interact with customers can determine whether a customer purchases goods or services from a business, both during an individual visit and on a recurring basis.

### Overview

A method of analyzing performance is disclosed herein. The method comprises capturing video data of an interaction between a customer and a worker. The method further comprises analyzing the video data to determine performance metrics for the interaction. The method further comprises generating a scorecard of the performance metrics.

In an embodiment, a computer-readable medium has stored thereon program instructions that, when executed by a processing system, direct the processing system to capture video data of an interaction between a customer and a worker. The program instructions further direct the processing system to analyze the video data to determine performance metrics for the interaction and generate a scorecard of the performance metrics.

In an embodiment, capturing the video data of the interaction between the customer and the worker comprises identifying the customer and the worker.

In an embodiment, capturing the video data of the interaction between the customer and the worker comprises identifying a location of the interaction within a retail environment.

In an embodiment, capturing the video data of the interaction between the customer and the worker comprises monitoring the location of the interaction.

In an embodiment, monitoring the location of the interaction comprises generating a virtual interaction by combining the video data and audio data for the interaction.

In an embodiment, analyzing the video data to determine the performance metrics for the interaction comprises identifying a duration of time that the customer waited at the location before the interaction between the worker and the customer began.

In an embodiment, analyzing the video data to determine the performance metrics for the interaction comprises identifying a duration of time of the interaction.

In an embodiment, analyzing the video data to determine the performance metrics for the interaction comprises correlating a number of conversions with the worker and identifying skills of the worker based on the number of conversions.

In an embodiment, analyzing the video data to determine the performance metrics for the interaction comprises correlating a conversion rate of the worker with a location of the worker and identifying a different location for the worker if the conversion rate falls below a threshold.

In an embodiment, a method of analyzing performance comprises capturing video data of interactions between customers and workers. The method further comprises analyzing the video data to determine performance metrics for the interactions, wherein the performance metrics comprise a ratio of an amount of the workers in an area to a total amount of the workers, a conversion rate for the area, and customer traffic within the area. The method further comprises processing the performance metrics to determine an optimal location to situate at least one of the workers. The method further comprises generating a scorecard of the performance metrics.

In an embodiment, processing the performance metrics further comprises processing the performance metrics to determine an optimal time period for scheduling the at least one of the workers to work at the optimal location.

### BRIEF DESCRIPTION OF THE DRAWINGS

FIG. 1 illustrates a block diagram of an example of a performance analysis system;

FIG. 2 illustrates a schematic diagram of a video processing system in an exemplary retail environment;

FIG. 3 illustrates a method of analyzing performance according to one example;

FIG. 4 illustrates a method of analyzing performance according to one example;

FIG. 5 illustrates a method of monitoring an interaction in a retail environment;

FIG. 6 illustrates a method of analyzing performance metrics according to one example;

FIG. 7 illustrates a method of analyzing performance metrics according to one example;

FIG. 8 illustrates a scorecard according to one example; and

FIG. 9 illustrates a computing device according to one example.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by claims and their equivalents.

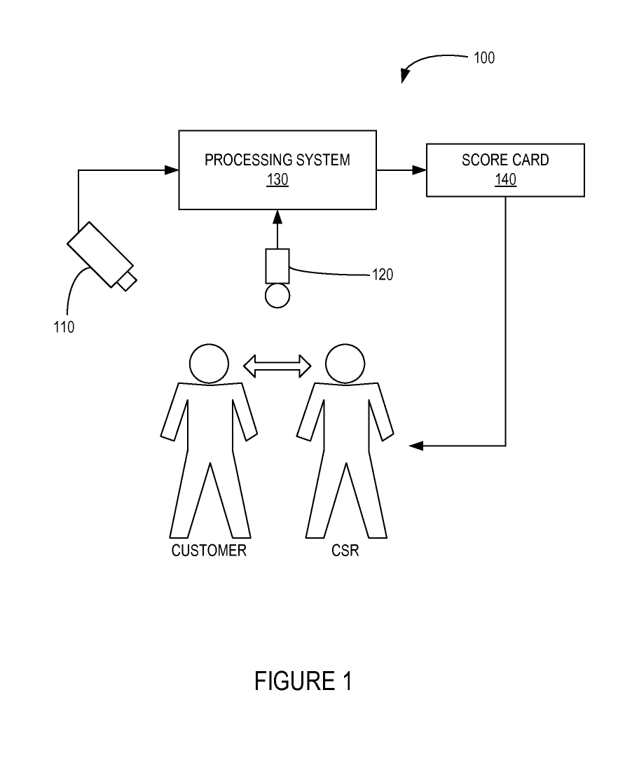

FIG. 1 illustrates a schematic view of an exemplary performance analysis system 100 that includes a video source 110 that is configured to capture video data of interactions between a customer service representative (labeled CSR in FIG. 1) and a customer. The video system 100 may also optionally include an audio source 120 configured to capture audio data of the interaction as well, though it will be appreciated that the audio source 120 may be omitted in some examples. Note that although FIG. 1 refers to a “customer service representative” (CSR), the terms “agent”, “worker”, “employee”, “contractor”, “service representative”, “CSR”, and similar terminology that describes different types of occupational relationships could be used herein interchangeably.

In at least one example, interactions between the service representative and the customer take place in a retail environment. As shown in FIG. 1, the performance analysis system 100 further includes a processing system 130 that is configured to analyze the video data captured by the video source 110 and/or audio data captured by the audio source 120. For example, the processing system 130 may be configured to analyze the video data to track the location of either or both of the service representative and the customer within the retail environment.

The processing system 130 may be further configured to determine a number of performance metrics related to the interaction. These performance metrics may be correlated and reported on a scorecard 140. The scorecard 140 can then be provided to the service representative. Various exemplary processes and configurations will be discussed in more detail hereinafter.

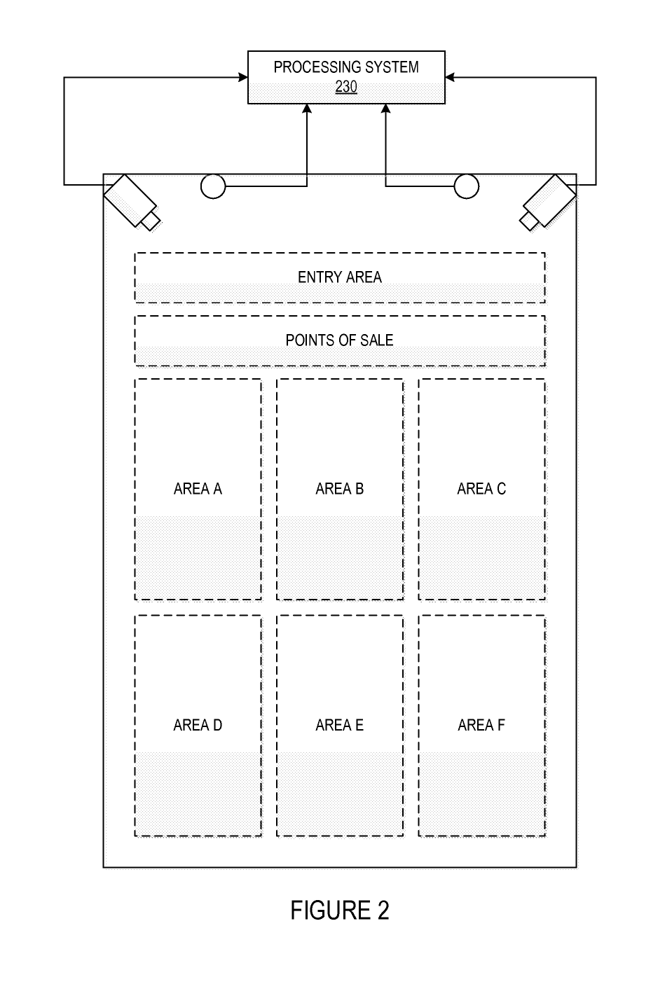

FIG. 2 illustrates a performance analysis system 200 that is utilized in a retail environment 205. As illustrated in FIG. 2, the performance analysis system 200 includes at least one video source 210 and optionally includes one or more audio source 220. The video sources 210 and the audio sources 220 are operatively coupled with a processing system 230.

In the illustrated example, the processing system 230 may be configured to identify the location of the interaction within the retail environment, to determine how long the customer has been in a given area, how long the customer was in the given area before the interaction between the service representative and the customer began, and/or the duration of the interaction. As will be discussed in more detail hereinafter, the processing system 230 may also be configured to correlate conversions to details of the customers visit, including interactions with service representatives.

As shown in FIG. 2, the retail environment 205 includes a number of areas, such as an entry area, and areas A-F. The retail environment 205 shown is divided into an arbitrary area configuration. It will be appreciated that a retail environment 205 may include any number of areas desired.

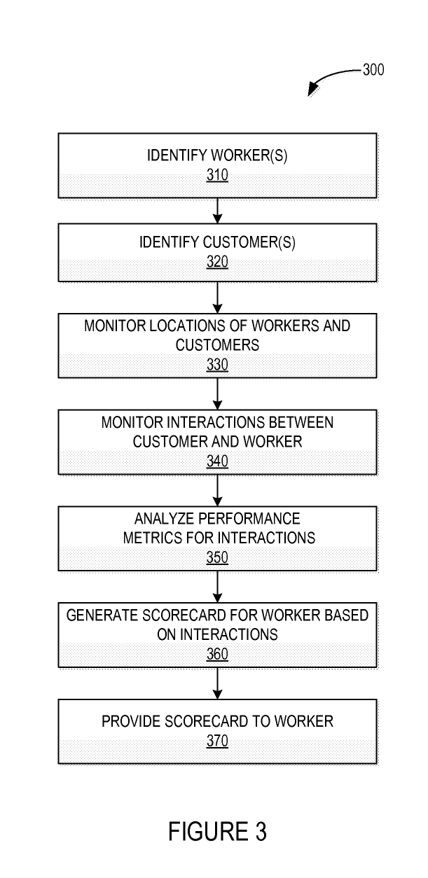

In at least one example, the processing system 230 is configured to identify workers and customers. The processing system 230 is further configured to analyze video data captured by the video sources 210 to determine performance metrics for the interactions. The processing system 230 is additionally configured to generate scorecards based upon or including the performance metric. FIG. 3 shows one exemplary method 300 of analyzing performance in an exemplary retail environment, such as the retail environment shown in FIG. 2. Accordingly, simultaneous reference will be made to FIGS. 2 and 3 for the following discussion of the exemplary method 300 of FIG. 3.

FIG. 3 illustrates a method 300 of analyzing performance according to one example. As illustrated in FIG. 3, the method 300 includes identifying worker(s) at step 310 and identifying customer(s) at step 320. In at least one example, the video processing system 230 shown in FIG. 2 may be configured to perform video analytics on the video data to identify workers and customers. Any suitable analysis may be performed on the video data.

Referring again to FIG. 3, once the worker(s) and the customer(s) have been identified, at step 330 the method includes monitoring the location of the workers and customers. Monitoring the locations of the workers and the customers may include determining the area in which the workers and customers are located, when they enter an area, when they leave an area, how long they are in each area, or other information about the locations of the workers and customers.

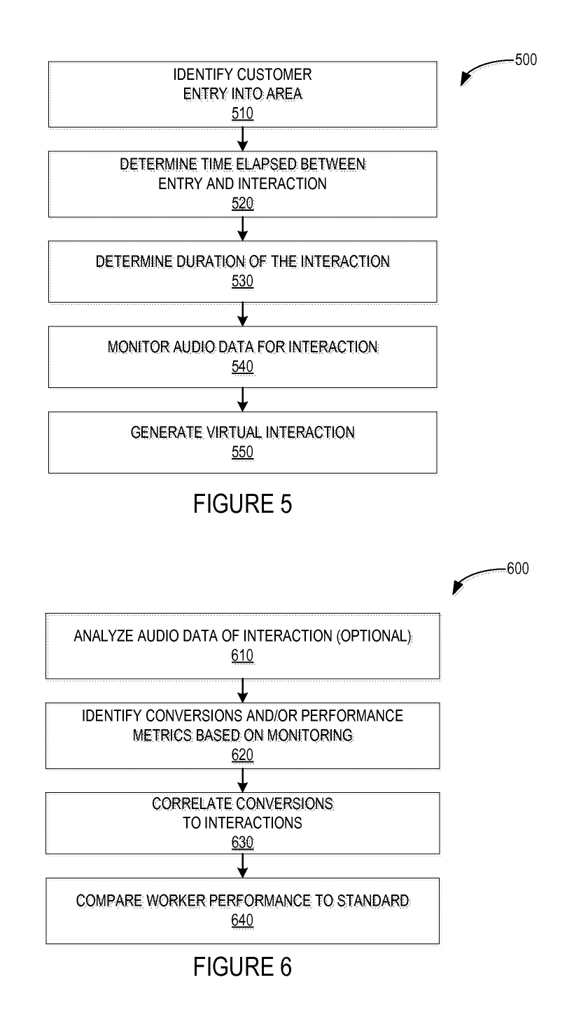

By monitoring the locations of the workers and the customers, the processing system 230 is able to monitor interactions between a customer and a worker at step 340. One exemplary method for monitoring interactions will be discussed in more detail with reference to FIG. 5.

In addition to monitoring interactions between customers and workers, the method shown in FIG. 3 includes analyzing performance metrics 350 for the interaction based on an analysis of video data. Audio data may also be analyzed, as well as transaction data. One exemplary method for determining performance metrics for the interactions will be discussed in more detail with reference to FIG. 6.

As shown in FIG. 3, the method for analyzing interactions also includes generating scorecards for the worker based on analysis of the interactions at step 360. Thereafter, at step 370, the scorecards are provided to the worker.

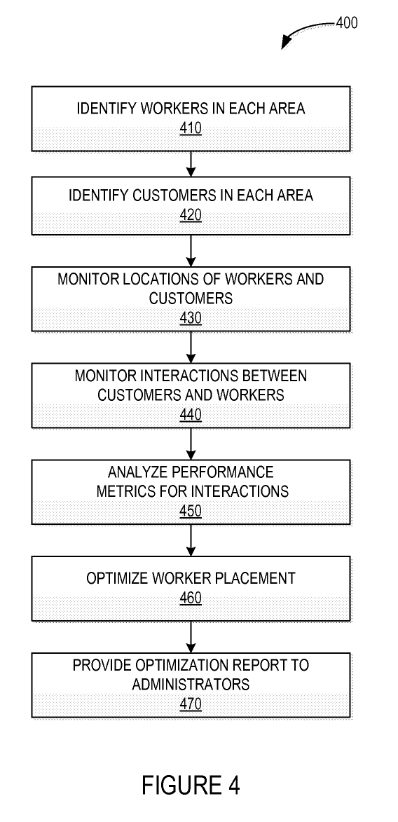

FIG. 4 illustrates a method 400 of analyzing performance according to one example. As shown in FIG. 4, the method 400 includes identifying workers in each area A-F at step 410 and identifying customers in each area A-F at step 420. In at least one example, the video processing system 230 shown in FIG. 2 may be configured to perform video analytics on the video data to identify workers and customers. Any suitable analysis may be performed on the video data. Identifying the workers and customers in an area includes counting the number of each that are in each area.

Referring again to FIG. 4, once the workers and the customers in each respective area A-F have been identified, at step 430 the method includes monitoring the location of the workers and customers. Monitoring the locations of the workers and the customers may include determining the area in which the workers and customers are located, when they enter the area, when they leave an area, how long they are in each area, or other information about the locations of the workers and customers.

By monitoring the locations of the workers and the customers, the processing system 230 is able to monitor interactions between customers and workers at step 440. Processing system 230 is also able to determine the relative traffic in each area A-F. However, traffic alone may not be an appropriate indicator of how to dedicate resources, such as placement of workers during a shift, when to schedule workers, and the like. A correlation of relative conversion rates, traffic, and worker placement and interactions may be used to optimize resource use. One exemplary method for monitoring interactions will be discussed in more detail with reference to FIG. 5.

In addition to monitoring interactions between customers and workers, the method 400 shown in FIG. 4 includes a step 450 of analyzing performance metrics for interactions. In particular, processing system 230 analyzes performance metrics for at least one interaction between a customer and a worker based on an analysis of video data. Audio data may also be analyzed, as well as transaction data. One exemplary method for determining performance metrics for the interactions will be discussed in more detail with reference to FIG. 6.

As shown in FIG. 4, the method 400 for analyzing interactions also includes optimizing worker placement based on the analysis at step 460. Thereafter, at step 470, the optimization reports are provided to an administrator.

FIG. 5 illustrates one exemplary method 500 for monitoring interactions between workers and customers in a retail environment using a processing system to perform video analytics. The method 500 may be performed in a processing system, such as processing system 230 of FIG. 2. As shown in FIG. 5, the method includes identifying customer entry into an area A-F at step 510. This step 510 may occur with respect to each area A-F into which a customer enters. For example, different workers may be responsible for different areas. Further, it may be desirable to know how many workers a customer interacts with throughout a visit to a store. For example, by performing this step for each customer, the system is able to count customers in a given area at a given time. Furthermore, by performing this step over time, the system is able to determine traffic flows and relative use of various areas for specified time periods.

As shown in FIG. 5, after a customer enters an area A-F, the processing system 230 of FIG. 2 determines the time elapsed between the customer's entry into an area and an interaction between the customer and a worker at step 520. The processing system 230 may also note if no interaction is initiated, though such a step is not specifically illustrated in FIG. 5.

In order to determine the time elapsed between a customer's entry into an area and initiation of the interaction, step 520 includes determining that an interaction between a worker and a customer has begun. Such a determination may be made in any desired manner. In at least one example, an interaction may be assumed when the worker(s) and the customer(s) are within a predetermined distance from each other.

In other examples, an interaction may be established when the processing system 230 determines an audio exchange is taking place between a worker and a customer based on an analysis of audio data, which is discussed in greater detail below.

As shown in FIG. 5, monitoring interactions between a customer and a worker may include determining the duration of the interaction at step 530. Determining the length of the interaction may include determining a duration of time when the worker and the customer are proximate to each other, a duration of time during which the worker and the customer are engaged in verbal conversation, and durations of other exchanges between the worker and the customer.

Accordingly, the method 500 may include monitoring audio data of the interaction at step 540. Determining which audio data is associated with the interaction may be achieved in any suitable manner. For example, workers may carry or wear microphones that directly capture audio data for the interaction. In other examples, the audio data may be identified through the use of directional audio technology, such as directional microphones and the like.

As shown in FIG. 5, the method 500 for monitoring an interaction may include generating a virtual interaction at step 550. Generating a virtual interaction may include combining the video data and audio data for the interaction. Further, generating a virtual interaction may include isolating the video data and audio data for the interaction from background noises or the like.

Though not shown, it will be appreciated that the processing system 230 may be further configured to track the movement of any number of customers and service representatives within any number of areas or regions within the retail environment.

Monitoring one or more interaction for a given worker yields data that may be analyzed to determine performance metrics. For example, a delay in initiating an interaction with a customer after the customer has entered an area may itself be a performance metric. Determining the duration of the interaction may also represent a performance metric. One example of determining additional performance metrics is shown in FIG. 6.

FIG. 6 illustrates a method 600 of analyzing performance metrics according to one example. In this example, audio data of interactions is optionally analyzed at step 610. In some examples, analyzing audio data of the interaction may include analyzing the audio data for keywords or phrases that would be used in an interaction appropriate for the retail environment. For example, in a home improvement retail environment, keywords related to tools, repair terms, or other jargon would likely be present if the interaction was properly focused. In some examples, workers may have certain scripted phrases or the like that should be used in interactions. These may be identified through analyzing audio data if so desired.

The method 600 continues at step 620 by identifying conversions and/or performance metrics based on monitoring. Conversions can comprise any desired action or transaction. Exemplary conversions include, without limitation, sales. In at least one example, the conversions may be realized at a point of sale, such as a cash register. Other conversions may be realized as desired.

At step 630, the conversions may be correlated to interactions. In particular, the methods described herein allow the processing system 230 to track customers within the various areas A-F of the store. The locations of items within the store may also be known. Accordingly, correlating conversions to interactions may include analyzing the path of a customer through the retail environment, identifying specific conversions, determining if an interaction occurred, and determining whether the specific conversions correspond with the location of the interaction. In other examples, the audio data may be analyzed to determine if keywords related to the specific conversion were part of the interaction.

In some examples, conversions may be correlated to interactions by tracking the customer to the point of sale and determining whether a conversion was concluded. Other processes for correlating conversions to interactions may also be utilized by making use of video analytics and optional audio analytics.

The data gleaned from steps 610-630 may be used to generate useful comparisons by comparing each performance metric to a standard at step 640. Accordingly, analyzing performance metrics for various interactions can provide insight into a worker's performance in maintaining interactions with customers as well as data as to whether those interactions were effective in realizing conversions.

As discussed above, the method of FIG. 6 for analyzing performance metrics may be part of a method for analyzing worker performance using video analytics in a retail environment.

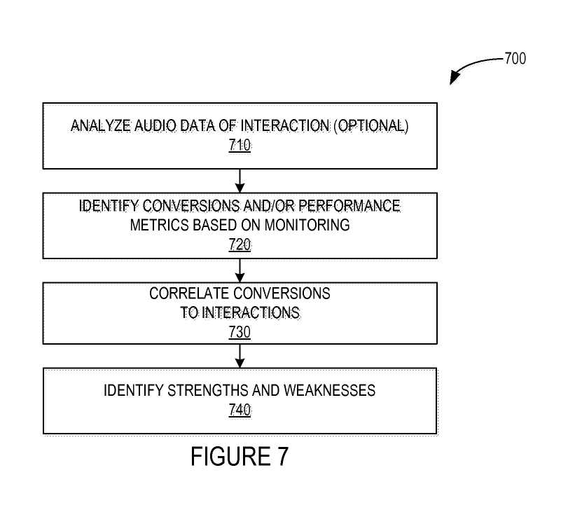

FIG. 7 illustrates a method 700 of analyzing performance metrics according to one example. In this example, audio data of interactions is optionally analyzed at step 710. In some examples, analyzing audio data of the interaction may include analyzing the audio data for keywords or phrases that would be used in an interaction appropriate for the retail environment. For example, in a home improvement retail environment, keywords related to tools, repair terms, or other jargon would likely be present if the interaction was properly focused. In some examples, workers may have certain scripted phrases or the like that should be used in interactions. These may be identified through analyzing audio data if so desired.

The method 700 continues at step 720 by identifying conversions and/or performance metrics based on monitoring. Conversions can comprise any desired action or transaction. Exemplary conversions include, without limitation, sales. In at least one example, the conversions may be realized at a point of sale, such as a cash register. Other conversions may be realized as desired.

At step 730, the conversions may be correlated to interactions. In particular, the methods described herein allow the processing system 230 to track customers within the various areas A-F of the store. The locations of items within the store may also be known. Accordingly, correlating conversions to interactions may include analyzing the path of a customer through the retail environment, identifying specific conversions, determining if an interaction occurred, and determining whether the specific conversions correspond with the location of the interaction. In other examples, the audio data may be analyzed to determine if keywords related to the specific conversion were part of the interaction.

The method 700 may also include determining a ratio of workers in the area, the conversion rate, and the customer traffic within the area. By comparing the relative costs with the value based on conversion rates, the system may be able to determine where to optimally place workers and when they should be placed there.

In addition, by counting the number of customers in a given area, such as a line, queue, or some other area, such as areas A-F shown in FIG. 2, processing system 230 may determine an additional performance metric. For example, it may be appropriate for a worker to spend more time dealing with a customer if there are only a few customers in the area. However, a longer interaction may be inappropriate if there are several customers in the area. Further, it may be appropriate for a relatively longer delay in initiating an interaction if there are several customers in the area since it may take some time to reach each of the customers.

In other examples, conversions may be correlated to interactions by tracking the customer to the point of sale and determining whether a conversion was concluded. Other processes for correlating conversions to interactions may also be utilized by making use of video analytics and optional audio analytics.

The data gleaned from steps 710-730 may be used to identify strengths and weaknesses of workers at step 740. In this manner, analyzing performance metrics of workers for various interactions can provide insight into a worker's performance in maintaining interactions with customers as well as data as to whether those interactions were effective in realizing conversions.

In at least one example, the analysis of interactions may help identify a worker's skills and weaknesses. For example, if the conversion rate associated with the worker's position in a given location is low, the worker may be better suited to work in a different area. Further, the audio data may be analyzed to determine the frequency of keywords the worker uses in interactions with customers. If the keywords that are most frequently used lead to conversions of products or services in other areas of the retail environment, the worker's skills may be better suited to other departments despite that worker's location in a given area. In such an example, the processing system may analyze the data as described above, correlate the conversions, and provide a report to a manager which may include possible suggestions based on the analysis.

As discussed above, the method of FIG. 7 for analyzing performance metrics may be part of a method for analyzing worker performance using video analytics in a retail environment.

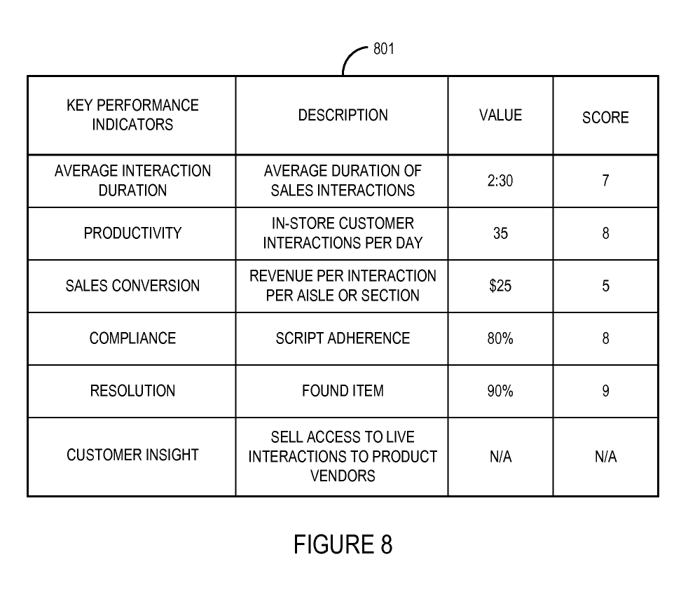

Referring again to FIG. 3, the method 300 includes generating a scorecard for the worker based on the analysis of interactions at step 360. The scorecard may include the comparisons described above, such as delay in initiating interactions, adherence to the use of desired keywords, duration of the interaction, conversion rates by location, or any other desired data. Also as shown in FIG. 3, the method 300 further includes providing the scorecard to the worker at step 370. In some examples, the processing system 230 may be configured to provide the scorecards to the worker automatically at desired intervals. One example of a scorecard for a worker based on an analysis of the worker's interactions with customers is provided with respect to FIG. 8.

FIG. 8 illustrates a worker scorecard 801 for customer interactions according to one example. Scorecard 801 comprises a list of key performance indicators (KPIs), descriptions of each KPI, values, and scores for each KPI for a particular agent. Of course, scorecards for multiple agents could also be generated, as well as scorecards for particular departments, sections, management groups, and any other like combinations. Further, in this example, scorecard 801 represents a single worker's performance for a single day, although different time periods could also be used in other examples, such as hourly, weekly, monthly, or annually. The information depicted in scorecard 801 represents exemplary worker scorecard data for a retail establishment.

Scorecard 801 has four columns labeled “KEY PERFORMANCE INDICATORS”, “DESCRIPTION”, “VALUE”, and “SCORE”. The “KEY PERFORMANCE INDICATORS” column designates KPI categories that were analyzed with respect to an agent. In some examples, a manager, supervisor, or some other administrator could select which KPI are analyzed for a given agent and/or scorecard. The “DESCRIPTION” column indicates the specific KPI being analyzed with respect to the KPI categories shown in the first column. The “VALUE” column provides a numerical value that indicates the agent's actual performance with respect to each KPI description. Finally, the “SCORE” column provides a normalized, numerical score for each KPI, which in this example is on a scale of one to ten, with a lowest score of one indicating that the agent needs improvement in a particular area and a highest score of ten indicating outstanding performance.

In FIG. 8, the first KPI category shown is the “average interaction duration”, which has an associated description of “average duration of sales interactions”, which provides a metric of the average amount of time the worker spent interacting with customers. In this example, the worker spent an average of two minutes and thirty seconds interacting with customers for sales transactions, which earned the worker a corresponding score of 7. The next KPI category, “productivity”, has a description of “in-store customer interactions per day” and a value of “35”, meaning the worker had 35 customer interactions during the day being analyzed, earning the worker a score of 8. The “sales conversion” KPI category measures the “revenue per interaction per aisle or section”. In this example, the worker generated an average revenue of 25 dollars per interaction per section of the store, with a corresponding score of 5.

The “compliance” KPI category looks at how well the worker complied with a script or predetermined sales pitch when interacting with customers. Typically, both video and audio would need to be analyzed to determine the level of script adherence achieved by the worker. In this example, the worker had an 80% script adherence percentage, yielding a score of 8 for the worker for this KPI category. The “resolution” KPI category looks at whether the customer found the item or items he was seeking in order to resolve the customer's inquiry. In this example, the worker assisted customers in finding their items of interest 90% of the time, earning the worker a score of 9. Finally, the “customer insight” KPI category looks at whether access to live worker/customer interactions could be sold to product vendors. Although no value or score is shown in scorecard 801 for this category, in some examples a score could be provided that indicates how valuable the customer interactions would be to product vendors to enable a manager to decide which specific customer interactions should be offered for sale. Of course, the KPI and related descriptions, values and scores shown in scorecard 801 are purely exemplary in nature, and any other KPI or other information could also be included in a worker scorecard for customer interactions.

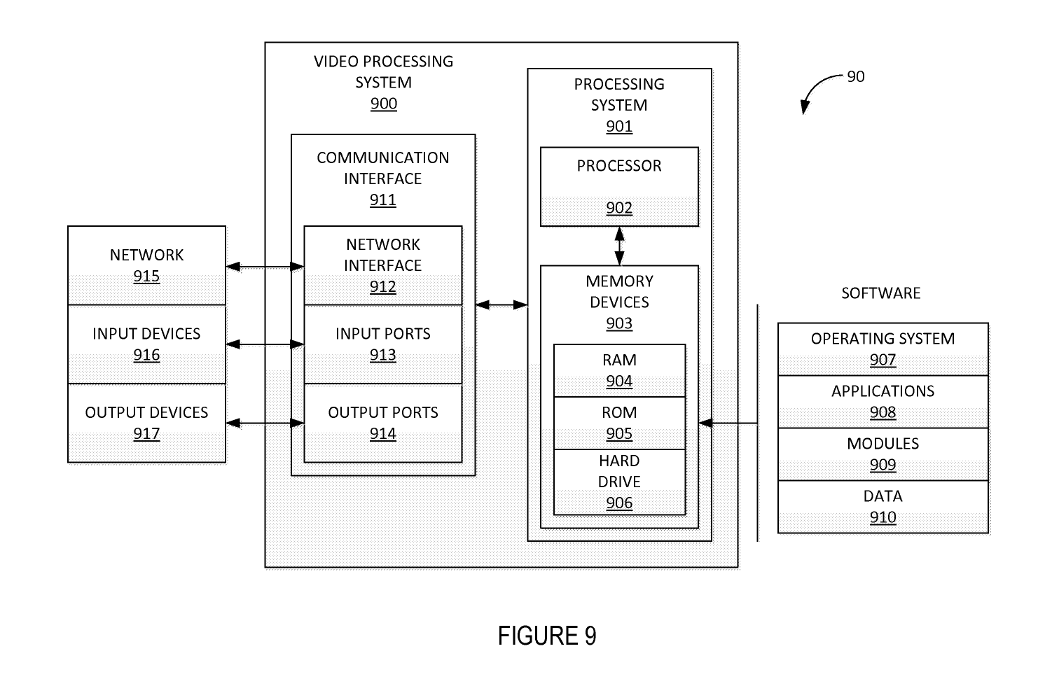

FIG. 9 illustrates a computing device 90 according to one example. The processing systems 130 and 230 described herein may be implemented on a computer system 90 such as that shown in FIG. 9. The computer system 90 includes a video processing system 900. The video processing system 900 includes communication interface 911 and processing system 901. Processing system 901 is linked to communication interface 911 through a bus. Processing system 901 includes processor 902 and memory devices 903 that store operating software.

Communication interface 911 includes network interface 912, input ports 913, and output ports 914. Communication interface 911 includes components that communicate over communication links, such as network cards, ports, RF transceivers, processing circuitry and software, or some other communication device. Communication interface 911 may be configured to communicate over metallic, wireless, or optical links. Communication interface 911 may be configured to use TDM, IP, Ethernet, optical networking, wireless protocols, communication signaling, or some other communication format—including combinations thereof.

Network interface 912 is configured to connect to external devices over network 915. Input ports 913 are configured to connect to input devices 916 such as a keyboard, mouse, or other user input devices. Output ports 914 are configured to connect to output devices 917 such as a display, a printer, or other output devices.

Processor 902 includes microprocessor and other circuitry that retrieves and executes operating software from memory devices 903. Memory devices 903 include random access memory (RAM) 904, read only memory (ROM) 905, a hard drive 906, and any other memory apparatus. Operating software includes computer programs, firmware, or some other form of machine-readable processing instructions. In this example, operating software includes operating system 907, applications 908, modules 909, and data 910. Operating software may include other software or data as required by any specific embodiment. When executed by processor 902, operating software directs processing system 901 to operate video processing system 900 to process and/or transfer video data as described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of analyzing performance, the method comprising:
capturing video data of an interaction between a customer and a worker;
analyzing the video data to determine performance metrics for the interaction; and
generating a scorecard of the performance metrics.

2. The method of claim 1 wherein capturing the video data of the interaction between the customer and the worker comprises identifying the customer and the worker.

3. The method of claim 1 wherein capturing the video data of the interaction between the customer and the worker comprises identifying a location of the interaction within a retail environment.

4. The method of claim 3 wherein capturing the video data of the interaction between the customer and the worker comprises monitoring the location of the interaction.

5. The method of claim 4 wherein monitoring the location of the interaction comprises generating a virtual interaction by combining the video data and audio data for the interaction.

6. The method of claim 3 wherein analyzing the video data to determine the performance metrics for the interaction comprises identifying a duration of time that the customer waited at the location before the interaction between the worker and the customer began.

7. The method of claim 1 wherein analyzing the video data to determine the performance metrics for the interaction comprises identifying a duration of time of the interaction.

8. The method of claim 1 wherein analyzing the video data to determine the performance metrics for the interaction comprises correlating a number of conversions with the worker and identifying skills of the worker based on the number of conversions.

9. The method of claim 8 wherein analyzing the video data to determine the performance metrics for the interaction comprises correlating a conversion rate of the worker with a location of the worker and identifying a different location for the worker if the conversion rate falls below a threshold.

10. A computer-readable medium having program instructions stored thereon that, when executed by a processing system, direct the processing system to:
capture video data of an interaction between a customer and a worker;
analyze the video data to determine performance metrics for the interaction; and
generate a scorecard of the performance metrics.

11. The computer-readable medium of claim 10 wherein the program instructions direct the processing system to identify the customer and the worker in order to capture the video data of the interaction between the customer and the worker.

12. The computer-readable medium of claim 10 wherein the program instructions direct the processing system to identify a location of the interaction within a retail environment in order to capture the video data of the interaction between the customer and the worker.

13. The computer-readable medium of claim 12 wherein the program instructions direct the processing system to monitor the location of the interaction in order to capture the video data of the interaction between the customer and the worker.

14. The computer-readable medium of claim 13 wherein the program instructions direct the processing system to generate a virtual interaction by combining the video data and audio data for the interaction in order to monitor the location of the interaction.

15. The computer-readable medium of claim 12 wherein the program instructions direct the processing system to identify a duration of time that the customer waited at the location before the interaction between the worker and the customer began in order to analyze the video data to determine the performance metrics for the interaction.

16. The computer-readable medium of claim 10 wherein the program instructions direct the processing system to identify a duration of time of the interaction in order to analyze the video data to determine the performance metrics for the interaction.

17. The computer-readable medium of claim 10 wherein the program instructions direct the processing system to correlate a number of conversions with the worker and identify skills of the worker based on the number of conversions in order to analyze the video data to determine the performance metrics for the interaction.

18. The computer-readable medium of claim 17 wherein the program instructions direct the processing system to correlate a conversion rate of the worker with a location of the worker and identify a different location for the worker if the conversion rate falls below a threshold in order to analyze the video data to determine the performance metrics for the interaction.

19. A method of analyzing performance, the method comprising:
capturing video data of interactions between customers and workers;
analyzing the video data to determine performance metrics for the interactions, wherein the performance metrics comprise a ratio of an amount of the workers in an area to a total amount of the workers, a conversion rate for the area, and customer traffic within the area;
processing the performance metrics to determine an optimal location to situate at least one of the workers; and
generating a scorecard of the performance metrics.

20. The method of claim 19 wherein processing the performance metrics further comprises processing the performance metrics to determine an optimal time period for scheduling the at least one of the workers to work at the optimal location.
